(19) United States
(12) Patent Application Publication
(10) Pub. No.: US 2025/0377851 A1
(43) Pub. Date: Dec. 11, 2025

(54) Apparatus and Method for Controlling a User Screen

(71) Applicant: CANON U.S.A., INC., MELVILLE, NY (US)

(72) Inventors: Attaullah Samsul Seikh, Irvine, CA (US); Shingo Murata, Mineola, NY (US); Stephanie Ann Suzuki, Irvine, CA (US); Hung Khei Huang, Irvine, CA (US)

(21) Appl. No.: 19/232,497

(22) Filed: Jun. 9, 2025

Related U.S. Application Data
(60) Provisional application No. 63/658,354, filed on Jun. 10, 2024.

(51) Int. Cl. G06F 3/14; G06F 3/0484

(52) U.S. Cl. CPC G06F 3/1454; G06F 3/0484

(57) ABSTRACT

An apparatus and method of controlling a display of a client device connected to an online communication session is provided and includes receiving, at a communication server from a client device, display control information assets that identify a display format and content streams being displayed on the client device operating in a first communication mode, distributing, by the communication server, the provided control information to at least one other client device determined to be operating in the first communication mode, and using, by the at least one other client device operating in the first communication mode, the distributed control information to obtain content streams and cause a user interface on the at least one other client device to have a same format and same content as the client device.

### CROSS-REFERENCE TO RELATED APPLICATIONS

This is a nonprovisional patent application that claims the benefit of priority from U.S. Provisional Patent Application Ser. No. 63/658,354 filed on Jun. 10, 2024, the entirety of which is incorporated herein by reference.

### BACKGROUND

### Field

The present disclosure relates generally to controlling a user interface display of participants during an online meeting collaboration.

### Description of Related Art

Online meetings between users is known including when a group of individuals at one location are communicating remotely with one or more individuals not presently located at the one location. Current online meeting solutions provide the ability to initiate a screen share feature whereby one participant of the online meeting can select a window or application executing on the user device to be provided as input to the online meeting and shared to all over participants in the online meeting. This allows for all users to view a common single screen so that all are able to see the same content. Other features exist whereby users who are not sharing the screen are able to request control such that a pointer (e.g. cursor) can be controlled by the non-sharing user so that the non-sharing user can interact with the content being shared. However, these solutions fail to provide a way for one user to direct the views of all other participants in an online meeting.

### SUMMARY

A method of controlling a display of a client device connected to an online communication session that includes receiving, at a communication server from a client device, display control information assets that identify a display format and content streams being displayed on the client device operating in a first communication mode, distributing, by the communication server, the provided control information to at least one other client device determined to be operating in the first communication mode, and using, by the at least one other client device operating in the first communication mode, the distributed control information to obtain content streams and cause a user interface on the at least one other client device to have a same format and same content as the client device.

A system is provided and includes at least one image capture device configured to capture an image of real space, a first device configured to execute a meeting room application that facilitates an online meeting between at least two client devices, the first device configured receives image captured by the at least one image capture device and that creates, from the captured images, one or more virtual data streams that are individually accessible by the at least two client devices connected to an online meeting and a communication server configured to execute a control method including includes receiving, at a communication server from a client device, display control information identifying a display format and content being displayed on the client device operating in a first communication mode; distributing, by the communication server, the provided control information to at least one other client device determined to be operating in the first communication mode; and using, by the at least one other client device operating in the first communication mode, the distributed control information to cause a user interface on the at least one other client device to have a same format and same content as the client device. A client terminal is provided and includes a display, one or more memories storing instructions; and one or more processors that, upon execution of the stored instructions, is configured to connect to an online meeting facilitated by a communication server between the client terminal and other client terminals remotely located from the client terminal, cause a user interface to be displayed on a display device, the user interface including user selectable image elements enabling selection of a number of windows to be displayed concurrently within the user interface, and selection of one or more content streams from a plurality of candidate content streams for inclusion in respective ones of the selected number of windows being displayed concurrently.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a system architecture according to an exemplary embodiment.

FIGS. 2A and 2B are a sequence of processing steps performed according to an exemplary embodiment.

FIG. 3 is an exemplary user interface generated in accordance with the processing steps performed by the exemplary embodiment.

FIG. 4 is a portion of the exemplary user interface shown in FIG. 3 that is generated in accordance with the processing steps performed by the exemplary embodiment.

FIG. 5 is an exemplary user interface generated in accordance with the processing steps performed by the exemplary embodiment.

FIG. 6 is an exemplary user interface generated in accordance with the processing steps performed by the exemplary embodiment.

FIG. 7 is an exemplary user interface generated in accordance with the processing steps performed by the exemplary embodiment.

FIG. 8 is a portion of the exemplary user interface that is generated in accordance with the processing steps performed by the exemplary embodiment.

FIG. 9 illustrates an exemplary hardware apparatus that executes the processing steps and generates the information used in creating the user interfaces according to the exemplary embodiment.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

In real-time communication environment such as an online meeting, the online meeting application needs to reduce data traffic. As a result streaming video data from online meeting system sometimes provides video data at a lower image quality. In the case of the meeting between individuals at one location such as a meeting room in an office space and one or more remote individuals (e.g. users at home), those individuals who are remote users can see only zoom-out view or zoom-in view which focuses on one object. Further, current online meeting applications are typically one-way distribution from a source to those remote users that are not at the source from where the video stream is being captured. It is difficult to change the streaming video according to a participant's operation which means that the remote participants are forced to see a predefined view of an image capture device and participants are not able to focus on what they want to see at the location from where the video stream is being captures. For these reasons, the meeting participants (remote users) are not able to see what they want to look at.

Additionally, in certain online meeting situations, it is important for a presenting participant to be able to direct the other participants in the online meeting to view certain pieces of content that may be relevant to the substance of the online meeting. A problem is presented when there are multiple different pieces of content that the presenting participant would like to show to the other participants. In certain instances, users may be able to select different content to be viewed during the online meeting but a drawback is that the content being selected by the participants may be irrelevant to what the presenter wishes to discuss. Another issue is that, by enabling different participants to select their own content to be viewed, it may result in different users considering different content while the presenting participant actually intends the other participants to focus on different content. To remedy these problems, the present disclosure advantageously describes a way to enable a first user connected to an online meeting via a first terminal/client device to force all other participants of an online meeting to view the same display windows in the same format and the same content in each of the windows are viewable at the same time by all other participants in the online meeting. In other words, the present disclosure enables a follow-me communication mode whereby, when engaged by the presenting user and agreed to by the other online meeting users, a first user device is designated as a leader and provides display control information is generated based on receipt of user interaction with the user interface to all other online meeting participant devices designated as followers. The control information is utilized by the other online meeting participant devices (e.g. followers) to cause respective displays of the follower devices to mirror the display of the leader device.

Accordingly, the present disclosure improves upon existing options for sharing content via screen share options which only provide a single piece of content to be shared to meeting participants. This is particularly the case where there is a plurality of content that is accessible and selectable within the online meeting. The present disclosure advantageously limits or otherwise focuses attention of the meeting participants on a select set of candidate content items and prevents user devices from accessing or viewing at the other content assets which may available in the online meeting. According to the present disclosure, the content being provided to the follower participants receive and are caused to display contents streams and the images directly individually from the server and not as one screen share. For example, if the leader screen has 4 assets being shown, 2 streams and 2 images. The participating users individually see that 2 streams and 2 images directly from the server as was provided to the server from their source. Finally, users can anytime exit the leader mode and see other assets or perform other actions available in the UI and go back to follow the leader by selecting various image elements from within the user interface.

The following disclosure illustrates an online meeting application that enables impromptu collaboration between users who may be physically located at one location such as an office and one or more individuals who are remotely located. The system advantageously assigns, manages and uses different identifiers in order to facilitate communication in this environment that allows remote users to have enhanced control over the field of view captured at the one location by an image capture device. As such, the remote user is able to view the one location according to the remote user definition or selection. This is accomplished by assigning user id information (virtual participant ID/Virtual Webcam ID) to each of a video captured by a camera at a meeting space and one or more cropped videos cropped from the captured video to enable an online meeting system to distribute these videos as well as videos of real participants.

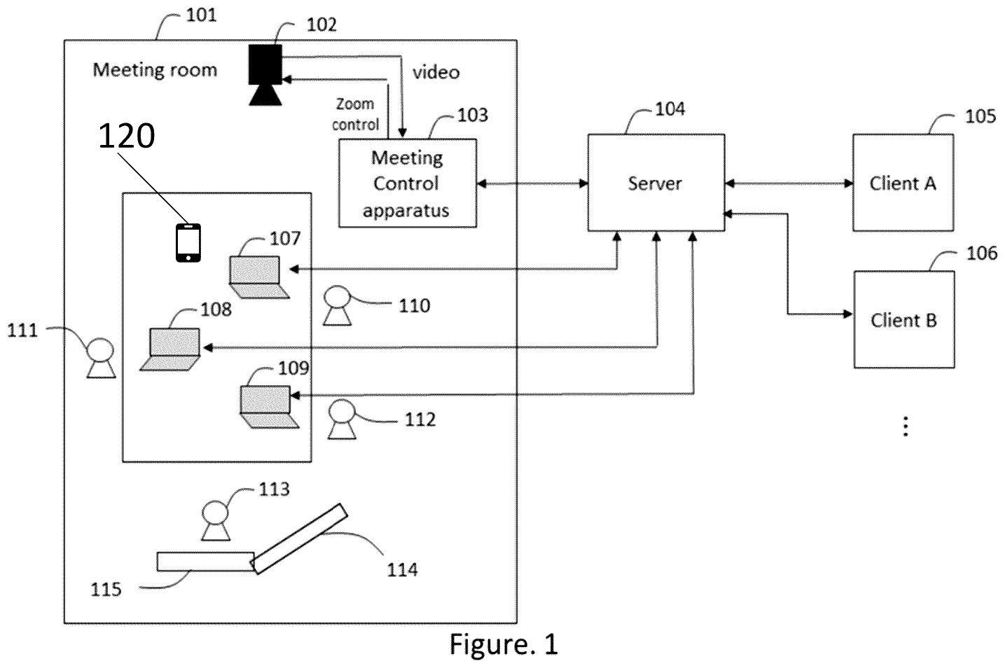

FIG. 1 illustrates a system architecture according to an exemplary embodiment. The system includes an image capture apparatus (a PTZ camera) 102, a meeting control apparatus 103, a server 104, a client computer A 105, a client computer B 106 and communication apparatuses 107-109. The communication apparatuses 107-109 can be a laptop computer, a tablet computer, a smartphone or other type of computer and are operated by respective attendees 110-112.

As illustrated in FIG. 1, the client computer A 105 and the client computer B 106 connect to, via a communication network, an online meeting held in the meeting room 101. In the present embodiment, the image capture apparatus 102, the meeting control apparatus 103, the communication apparatuses 107-109, the attendees 110-112, a presenter 113 and white boards 114-115 can be present in the meeting room 101, but this is not seen to be limiting. In another exemplary embodiment, for example, the functionality provided by the meeting control apparatus 103 as described below can be located in the cloud.

The meeting control apparatus 103 includes all the local modules, such as gesture recognition module, image capturing apparatus control module (pan/tilt/zoom), and meeting state management module. The server 104 manages meeting resources, and communication/synchronization between clients and modules included in the meeting control apparatus 103.

The image capture apparatus 102 captures video in the meeting room 101 while a meeting is in progress. The image capture apparatus 102 captures gestures by the attendees 110-112 and the presenter 113. The captured video is transmitted to the meeting control apparatus 103. As described above, the meeting control apparatus 103 can recognize user's gesture included in the video, and execute the process corresponding to the gesture.

Once the online meeting starts, the client computer A 105 and the client computer B 106 can display the video captured by the image capture apparatus 102 so that remote attendees can view what is going on in the meeting room 101, including anything that may be written on the white boards 114-115. The communication apparatuses 107-109 can display the same video so that attendees 110-112 are able to view what the remote attendees are viewing.

The attendees 110-112 can use a mobile phone 120 for the online meeting. As stated above, the image capture apparatus 102 feeds a video (image data) to the online meeting. However, there is a situation that the image capture apparatus 102 fails to capture high-resolution video of a particular area of the meeting room 101 while capturing a video of overall area of the meeting room 101. In that situation, the attendees 110-112 can use the mobile phone 120 to capture the high-resolution video of the particular area and feed it to the online meeting.

In the system described with reference to FIG. 1, all images captured by the image capture apparatus 102 and/or a mobile phone 120 are designated as content assets and provided with unique virtual identifiers that are joined to an online meeting between one or more users. Additionally, content assets may include information and/or data derived from or generated by an application executing on a computing device such as a laptop or tablet and/or mobile device 120. In a case where content assets representing content to be shared and made accessible to all users of the online meeting, each content asset includes a unique identifier that denotes the content asset and a source for that particular content asset.

In one embodiment, the meeting control apparatus includes a meeting application executing thereon. In certain embodiments, the meeting application performs video image cropping operations to crop predetermined regions of the images being live captured by image capture apparatus 102. These cropped regions are extracted by the meeting application executing on a server and controlled to be a source of a content asset for which individual virtual participant data streams are generated and supplied to be accessible by the meeting participants. Accordingly the cropped streaming video regions created by the meeting application represent respective virtual video feeds that are provided as inputs to feed and transmit the individual cropped video streams to the server 104.

In another embodiment, whiteboards 114 and 115 are captured by the image capture apparatus 102 and designated as a content asset that is to be made available for view by all meeting participants. In this embodiment, one or more whiteboard content data streams are generated based on recognizing the position and location of whiteboards 114/115 within the image being captured by image capture apparatus 102. In certain instances, the meeting control apparatus designates a defined location within the field of view corresponding to whiteboards 114/115 and extracts the region within the defined location as the whiteboard content data streams. In another embodiment, a sub-region within the designated location can be cropped based on one of selection of a boundary using a user interface or performing a gesture by a user that is then captured by the image capture apparatus and processed to indicate that the sub-region of the whiteboard 114/115 should be further cropped and extracted and provided a spotlight content asset viewable by online meeting participants.

The meeting control application executing on meeting control apparatus 103 interacts with the online meeting application executing on the server 104 which controls the backend meeting processing including audio communication between participants that have joined the current online meeting session. In one embodiment, the online meeting session is initiated using a control application such as MICROSOFT TEAMS® or other similar type of application. Each content asset is assigned a unique identifier and is provided to the server 104 which then distributes the content assets to respective participants that select the content assets from within the user interface on their own respective client/terminal device.

The various content asset data streams are communicated to one or more remote users that are able to display an augmented user interface that enables display of one or more of the content asset data streams in different regions of the user interface. The meeting session includes an identifier that is selectively accessible using a web browser executing on a computing device such as a laptop, desktop, smartphone or tablet computer. The meeting session identifier provides a series of individual video sources that can be rendered within a web browser user interface and, as will be discussed hereinafter, enable a user to selectively choose from the plurality of content asset data streams and also enable a user to be designated as a leader and select particular content assets streams to be positioned in a defined region within the user interface and generate control information identifying the format and content which is then provided, via the meeting session, to other participants whose user interfaces will be control to display in the same format with the same content as that of the leader based on the control information generated by the leader.

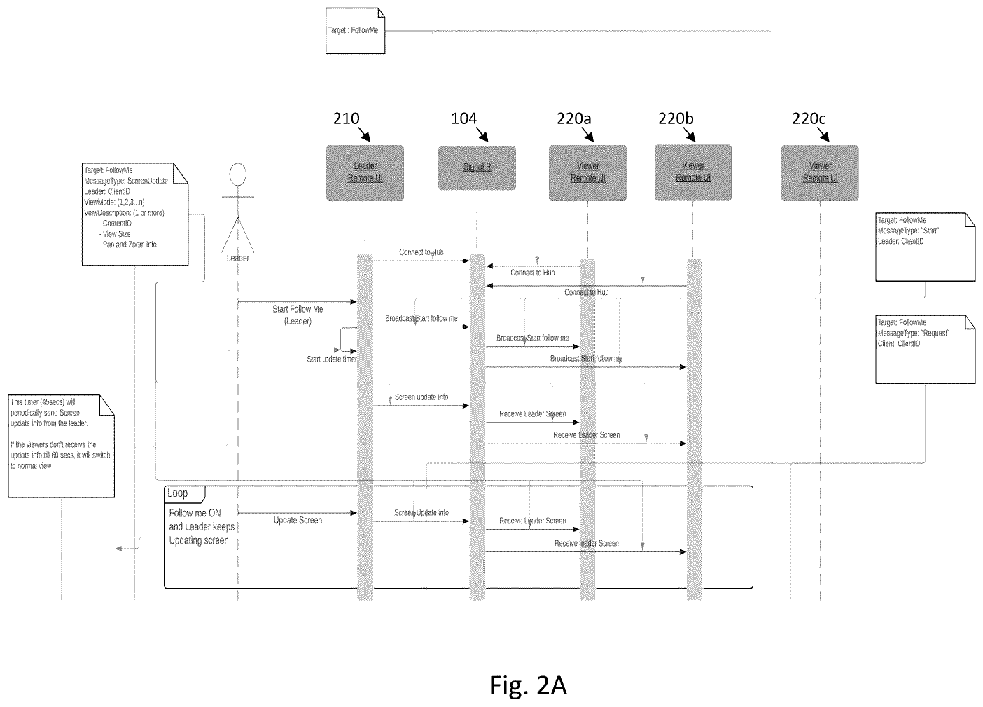

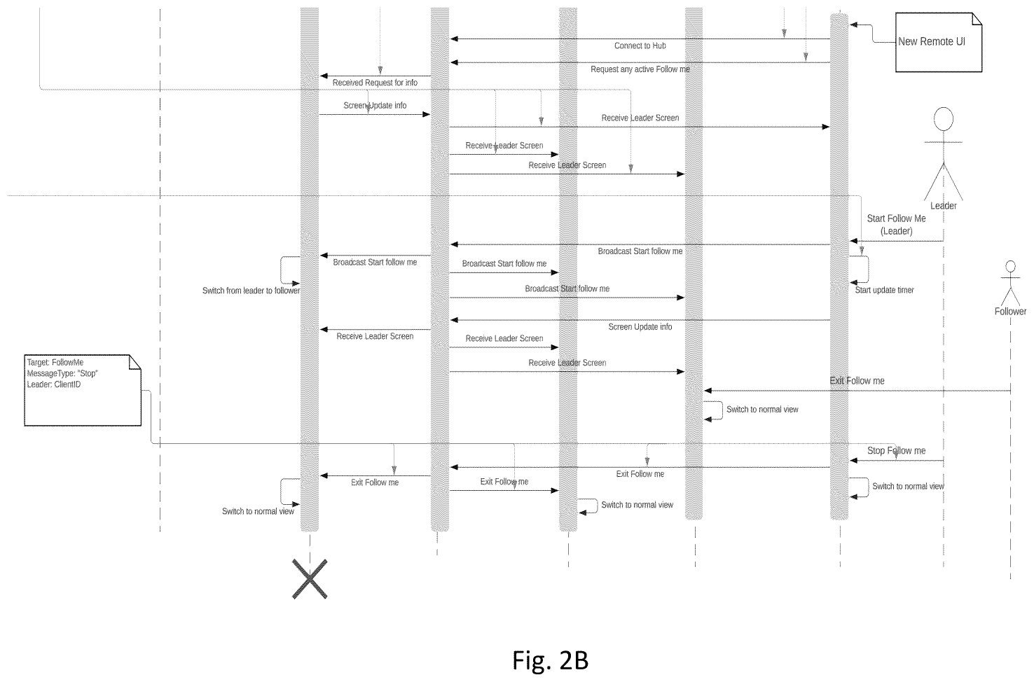

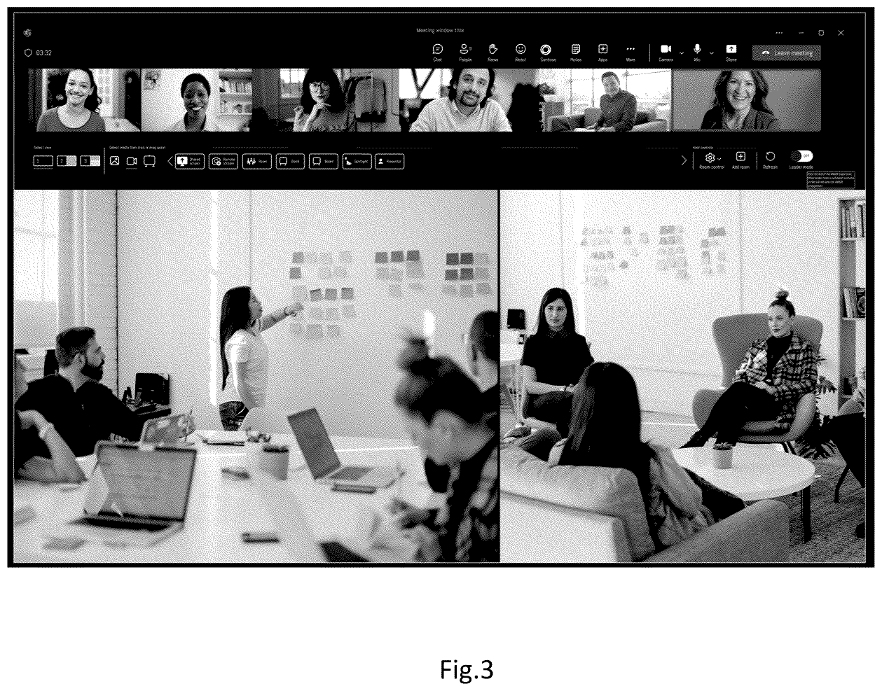

The algorithm executed by the server 104 which is a communication server will be described hereinbelow with respect to the processing sequences shown in FIGS. 2A and 2B and illustrated in the user interface screen shows shown in FIGS. 3-8. The algorithm is stored as a series of instructions that are executed by one or more processors of a computing device such as the communication server 104 in FIG. 1.

As shown in FIGS. 2A and 2B is a sequence of processing steps between a first user operating a first client device 210, the communication server 104, and other client devices 220a-220c. In operation each of first client 210 and other clients 220a-220c connect to the communication server 103 which facilitates an interactive online meeting between all clients including sharing and visualizing content assets and bidirectional audio and video communication between all clients. Additionally, the meeting control apparatus 103 includes a meeting control application executing thereon controls the provision and addition of content assets to the online meeting which is facilitated by the communication server 104.

In exemplary operation a meeting feature (Target: FollowMe) is configured as feature object provided by the communication server and is caused to be selective displayed within a user interface on each of the client devices connected to the meeting. The feature object is selectable by a user and, upon selection thereof by a respective client device, causes the selecting client device to operate in the first communication mode. In exemplary operation the first communication mode is a “follow me” mode whereby one client device is a leader client device, and all other client devices are designated as follower client devices. In this mode, the user interface display and content being displayed therein of the leader client device is used to define the display format and content on all follower client devices based on control information generated using display format and content information from the leader client device which is then broadcast to and used by each of the follower client devices to control the display of the user interfaces thereon.

In the first communication mode the leader picks different options on the user interface, such a 1-view, 2-view, 3-view and 4-view modes which will be reflected on the screen of all other users who are followers and who are following the leader. The leader can even drag and drop or otherwise insert content assets in the meeting, such as a video data stream or an image and the content asset will be reflected on the other remote user's screen. In other exemplary operations, the leader client device can selectively interact with the types of views and modify a size of one or more windows that comprise the 1-view, 2-vew, 3-view or 4-view selections. For example, in a case where 3-view mode is selected causing the user interface on the leader client device to display three view of three content assets, a size of the respective windows can be modified such that a first view occupies 50% of the user interface display area while the other 2 views occupy the other 50% of the screen. Size, position and content modifications can be performed by the client leader device and control information will be generated and/or updated to reflect any changes at periodic time intervals so that the user interfaces displaying on the follower client devices reflect any changes/modifications made by the leader thereby helping the users of the follower devices to focus only on the content items chosen by the user of the leader client device.

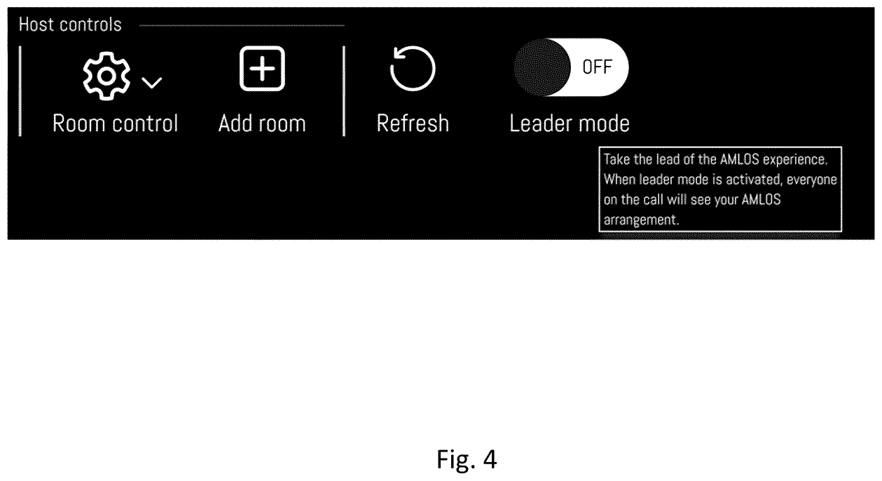

The following processing sequence will be described whereby client device 210 will be designated as the leader devices and all other client devices 220a-220c will be designated the follower devices. An exemplary user interface for each of the client devices is illustrated in FIG. 4. In this user interface there is a participant region which display indicators corresponding to participants operating the various client devices. In one embodiment, the indicators are tiles having video data captured by, for example, webcams of respective client devices. In one embodiment, the participant region is generated by the communication server that govern bidirectional audio and video communication between devices. The user interface in FIG. 4 also illustrates a meeting control region positioned below the participant region. In the meeting control region, a plurality of user selectable image elements are present that allow the user to change various aspects of the user interface. In one sub region, window selection icons are disposed and, upon selection thereof, cause the content region to change a number of windows (e.g. tiles) being displayed therein. As shown in FIG. 4, a 2-view mode is selected thereby causing the user interface to display two windows. Additionally, user selectable image elements representing various content assets are also disposed within the user interface. A user can select a respective content asset image element and cause content associated therewith to be displayed in one (or both) of the selected windows. Each content asset includes a unique identifier that is associated with its respective content asset image element and is used to source the content asset from its location for display in the designated window.

While a two view mode is shown in FIG. 3, it should be understood that the region can be configured display any number of windows between 1 and 4 wherein each content window has its own content asset being displayed therein.

The user interface further displays a feature selector illustrated herein as “leader mode” which is caused to be displayed by the feature target configured in the communication server. FIG. 4 illustrates an enlarged region of the UI in FIG. 4 that illustrates the selectable toggle to initiate the first communication (e.g. leader mode). By toggling the feature selector in FIG. 4, the client device on which it was toggled is designated as the leader client device, which, as shown in FIG. 3, is device 210.

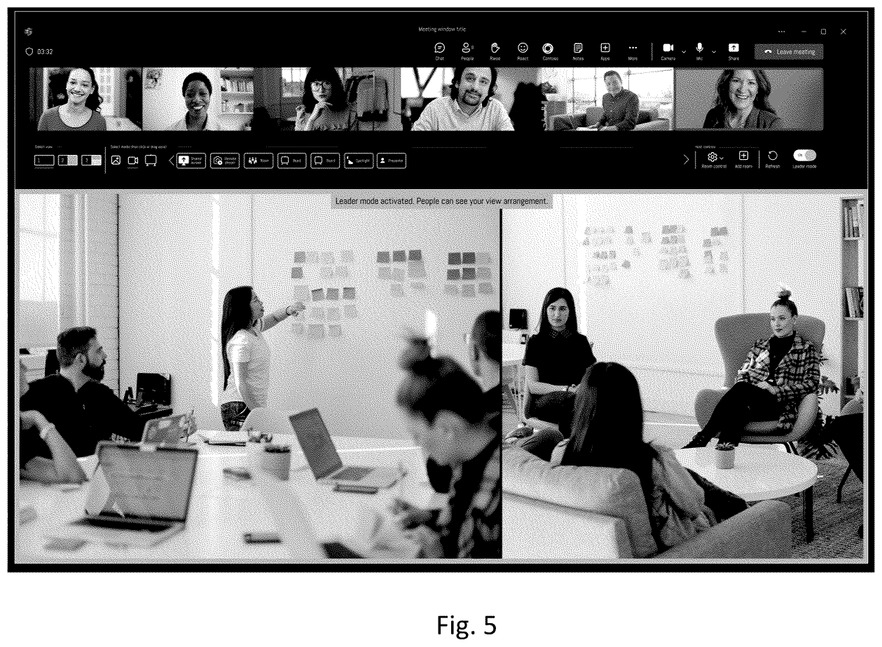

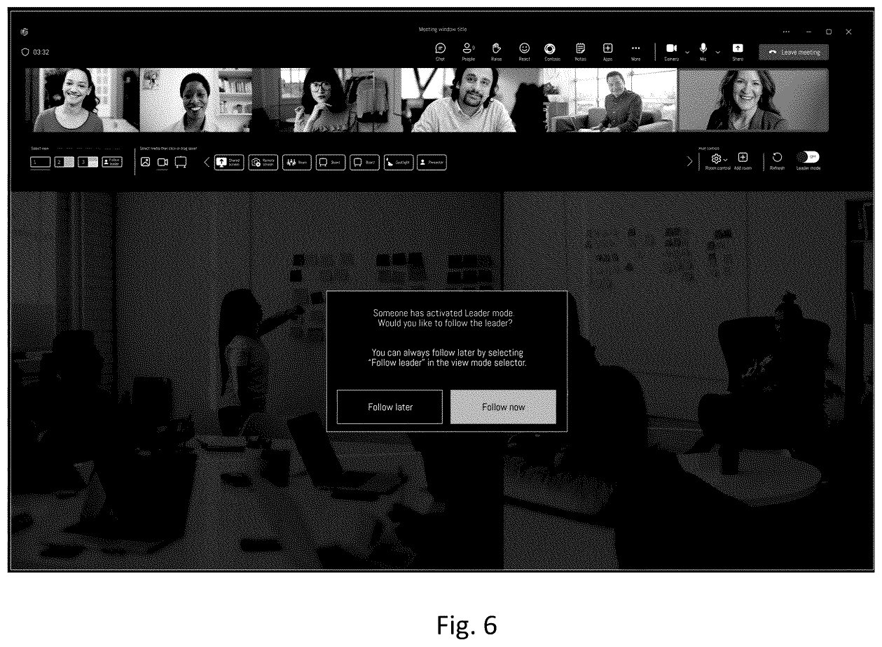

Turning back to FIG. 3, client device 210 and 220a-220c connect to the communication server 104. Once the feature selector is toggled on by client device 210, the first communication mode (e.g. leader mode) is initiated. This is illustrated in FIG. 5 whereby the UI from FIG. 3 is now presented with a visual indicator that their user interface format and content is available to any other client device who also enters the first communication mode as a follower device. Concurrently with selecting the feature selector, a mode initiation message is communicated to each of client devices 220a-220c notifying them of the change in communication mode and enabling each respective one of device 220a-220c to determine if they want to enter the first communication mode as follower devices. This is illustrated in FIG. 6 whereby mode selection image elements with the notification message are caused to be displayed within the UI of all client devices other than the leader device 210. In this example, devices 220a and 220b have elected to become follower client devices.

Once the first communication mode is initiated, the client device 210 generates control information object. In one embodiment, the control information is a JSON object and includes display format and content asset information. This includes information about the meeting assets and also their location on the screen and the sizes. This design does not limit to any specific information but can be expanded to any features which is implemented for the user to see.

An exemplary JSON data object is shown below and represents control information generated by and sent from the leader device to all follower devices.

```
  {
  “client_id”: “gi6kwiz2mfr”,
  “data”: {
        “client_id”: “gi6kwiz2mfr”,
        “group”: “24c20e27-4743-4849-afd1-f8f591738e15”,
        “tile_configs”:
      “{\“splitPercentage\”:53.624928143915064,\“direction\”:\“row\”,\“first\”:\“d58a5006-
      f616-4171-959e-c9f2992059cf\”,\“second\”:\“2ce5fd0a-68cf-474c-b92b-
      71576a58711c\”}”,
        “tiles”: “[\“room|Harry Room||LPP00142486S.fsoft.fpt.vn\”,\“a110ef0c-acf1-4cd2-8119-
      ac6d8e6af21a@52435eee-fbfe-43a7-87fa-
      0e812325c0@image|Whiteboard|Board4|a110ef0c-acf1-4cd2-8119-ac6d8e6af21a\”]”
    }
  }
{
```

The object includes a client ID is the unique id generated when user of the remoteUI joins the meeting. This is sent so that when a message comes from the communication server, RemoteUI can know that message comes from the leader and process it accordingly. (The leader will not have to process this message). The value of tiles in the object represent an array which contains the information of the content in each view. This contains information for the UI, to display the said asset and also how to display the asset, such as which view and what percentage of the screen and tile_configs represent the size of the views.

Once the control information object is generated, it is provided to the communication server 104 which then provides the control information object to each of device 220a and 220b. Those client devices use the information in the control information object to control the user interface being displayed thereon to mirror the user interface being displayed on client device 210. An update timer is initiated whereby the leader client device 210 is continually monitored to determine if any updates to the leader user interface have been made and, if so, then updated control information object is generated and provided to the server 104 and distributed to devices 220a and 220b such that their user interfaces can be controlled to be updated accordingly. This is shown by the processing loop in FIG. 2A.

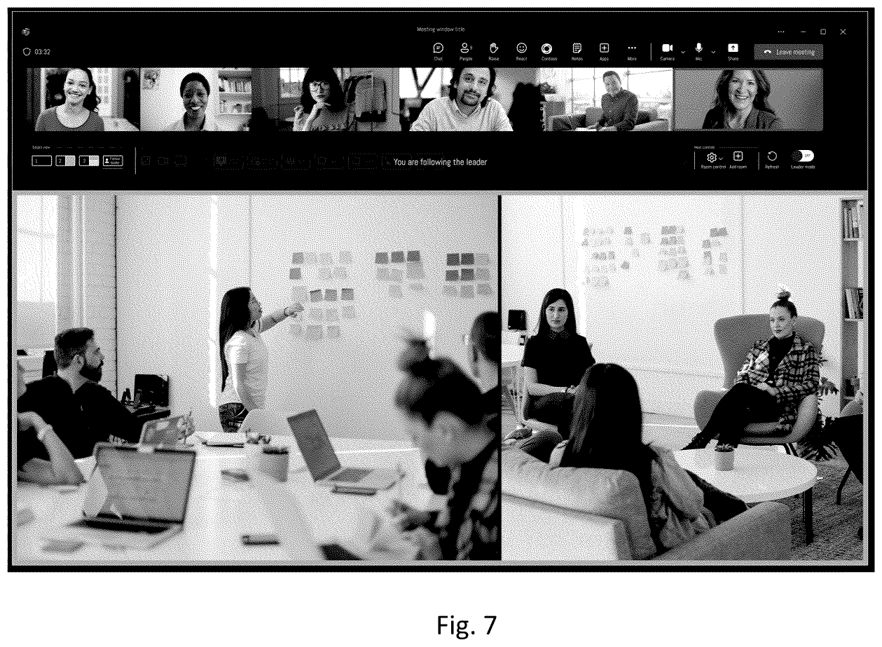

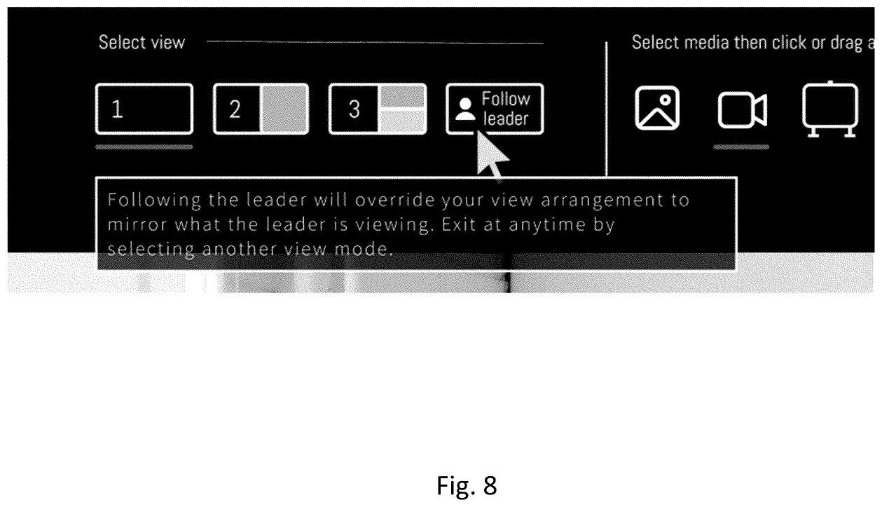

In a case where client device 220c did not join as a follower device initially at a same time as devices 220a and 220b, the user interface shown in FIGS. 7 and 8 provide an image element allowing the user of device 220c to enter the first communication mode. Specifically, in FIG. 8, the enlarged view illustrates the image element that indicates that the first communication mode is active and that selection of the image element will cause the device 220c to enter the first communication mode as a follower client device. This process is illustrated on the right of FIG. 2B which illustrates an object joining as a new remote UI. Once joined, device 220c connects to the server 104 and requests information associated with the first communication (e.g. leader mode). The server 104 requests the most recently generated control information and provides it to device 220c such that the user interface of device 220c can be configured to mirror the user interface of device 210. These operations continue until one or more of the client devices exit the first communication mode and enter the second communication mode whereby each client device can selectively choose the configuration of their respective user interfaces.

In another embodiment also illustrated in FIG. 2B, client device 220c is caused to initiate the first communication mode resulting in device 220c being the leader client device. This request is provided to the server 104 which communicates it back to client device 210 who is currently designated as the leader client device and to client devices 220a and 220b. In one embodiment, when a currently designated leader device receives the request for another device to be a new leader device, the currently designated leader device can prevent the change in leader designation. In another embodiment, a notification message as shown in FIG. 6 is caused to appear. As discussed above, a user of the client device can then select if the current leader should now be designated a follower. In the case where 220c is designated the new leader device, the first communication mode is continued and operates a described above.

When a current leader, in this case device 220c, determines that the first communication mode should be ended, a request to exit the first communication mode is generated and causes the respective client device to change from the first communication mode to the second communication mode whereby respective client devices can receive input from their users to selectively determine the configuration and content assets that are available for display.

The operations described in FIGS. 2-8 are claimed in the claims appended hereto. The features of these claims are hereby incorporated into the body of the specification and represent exemplary operations shown herein. Embodiments of the present disclosure include a method of controlling a display of a client device connected to an online communication session that includes receiving, at a communication server from a client device, display control information identifying a display format and content being displayed on the client device operating in a first communication mode; distributing, by the communication server, the provided control information to at least one other client device determined to be operating in the first communication mode; and using, by the at least one other client device operating in the first communication mode, the distributed control information to cause a user interface on the at least one other client device to have a same format and same content as the client device.

Another embodiment includes continually checking, by the communication server, at predetermined time intervals for updated control information; and using, by the at least one other client device operating in the first communication mode, the updated control information to cause the user interface to be modified in accordance with the updated control information.

Another embodiment, includes receiving, by the communication server, an operational mode signal that indicates that the client device is caused to operate in the first communication mode, providing the operational mode signal to each of the at least one other client device, causing the user interface on each of the other client devices to display a selectable image element on the user interface to notify the at least one other client device that the client device is operating in the first communication mode, and enabling receipt of a selection by each respective one of the at least one other client devices indicating whether to operate in the first communication mode. The receipt of the selection indicating that the respective other client device is to operate in the first communication causes the respective other client device to use the distributed control information to cause the user interface to have the same format and same content as the client device. The receipt of the selection indicating that the respective other client device is not operating in the first communication mode causes the respective other client device to operate in a second communication mode whereby the respective other client device provides second control information to the communication server that allows a user of the respective other client device operating in the second mode to define its own display format and content.

Embodiments, further include enabling the client device and some of the at least one other client devices to operate in the first communication mode and others of the at least one client device to operate in the second communication mode.

In other embodiments, information identifying a display format indicates a number of individual display windows and respective sizes for each of the number of individual display windows. Information identifying content being displayed includes a content source identifier selected from among a plurality of available content sources, wherein the plurality of available content sources each have a respective content source identifier and is includes at least one or more of (a) first live video data captured by a first image capture device; (b) a second live vide data selected from a region within the first live video data; (c) a still image captured by the first image capture device or a second image capture device different from the first image capture device; and/or (d) data provided by an application executing on the client device.

According to certain embodiments, the first operational mode is a leader mode identifying the client device as the leader and causes all other client devices connected to the communication server and operating in the first communication mode to be designated as a follower and have a same user interface and content view as the leader. This further includes receiving, by the communication server, a mode change signal from the one of the other client devices designated as a follower requesting that the one of the other client devices designated as a follower become the leader; and notifying a current leader and all other current followers that a respective one of the followers is to become a new leader and change a status of the current leader to a follower. In other embodiments the method provides enabling, in response to the notification, the current leader to prevent the follower who issued the mode change signal request from being the new leader and in response to becoming the new leader; provide updated control information to the communication server representing display format and content associated with the new leader, distributing, by the communication server, the updated control information to all followers; and using the distributed updated control information to cause all followers to have a display format and content same as the leader.

In other embodiments the method includes receiving, by the communication server from one or more of the other client devices, a mode change signal indicating a change from the first communication mode to a second communication mode, whereby in the second communication mode the one of the one or more other client devices does not use the control information provided by the client device.

Further embodiments of the method include providing, by the communication server, a feature indicator that is displayed within user interfaces on each of the client devices, to cause operation in the first communication mode; and in response to the first communication mode being enabled by a respective one of the client devices, updating the user interface on each of the client devices operating in the first communication mode, to include a selectable image element that enables a selection causing each of the other client devices to exit the first communication mode and enter the second communication mode.

A communication server is provided and includes one or more memories storing instructions; and one or more processors that, upon execution of the stored instructions, are configured to execute a control method described hereinabove.

A system is provided and includes at least one image capture device configured to capture an image of real space, a first device configured to execute a meeting room application that facilitates an online meeting between at least two client devices, the first device configured receives image captured by the at least one image capture device and that creates, from the captured images, one or more virtual data streams that are individually accessible by the at least two client devices connected to an online meeting and a communication server configured to execute a control method according to any of the embodiments described hereinabove.

In other embodiments of the system, the first device is further configured to generate virtual data streams corresponding to one of an image or video captured by a second image capture device communicatively connected to the first device. In further embodiments of the system each of the virtual data streams includes a unique identifier enabling a client device connected to the online meeting control to access content included in the virtual stream for display within one or more windows in a user interface on the client device. Control information may include a number of windows currently being displayed on the client device and associated unique identifiers for content displayed within each of the number of windows. The communication server is further configured to use the unique identifiers in the control information to provide content associated therewith to a same window at a same position in each user interface on each client device connected to the online meeting facilitated by the first device.

A client terminal is provided and includes a display, one or more memories storing instructions; and one or more processors that, upon execution of the stored instructions, is configured to connect to an online meeting facilitated by a communication server between the client terminal and other client terminals remotely located from the client terminal, cause a user interface to be displayed on a display device, the user interface including user selectable image elements enabling selection of a number of windows to be displayed concurrently within the user interface, and selection of one or more content streams from a plurality of candidate content streams for inclusion in respective ones of the selected number of windows being displayed concurrently. The client terminal further configured to receive a communication mode selection that notifies the other client terminals that the client device is to control the user interfaces being displayed on the other client devices to mirror the user interface being displayed on the client terminal, generate control information used to control the user interfaces displayed on the other client terminals that includes the selected number of windows and an identifier indicating a source of the content stream associated with the selected windows; and provide the generated control information to the communication server which distributes the control information to the other client terminals to cause the user interfaces on the other client terminals to use the control information to mirror the display of the client terminal.

In other embodiments, the client terminal is configured to continually monitor the user interface for any changes in number of windows selected for concurrent display and changes in content being associated with any selected windows; and update the control information to reflect the changes when it is determined that a change has occurred; and provide updated control information at a predetermined interval to the communication server to update displays on the other client terminals. In response to determining no change has occurred provide the generated control information at the predetermined interval to the communication server. The client terminal is further configured to exit the selected communication mode and cause all other client terminal devices to exit the communication mode.

In another embodiment, the client terminal is configured to receive a notification from the communication server issued by one of the other client terminals indicating that the one of the other client terminals intends to operate in the communication mode to mirror a user interface of the other client terminal on the client terminal; generate a message corresponding to the received notification for display in the user interface; and receive a selection from within the generated message indicating whether the client terminal will enter the communication mode.

A control method for controlling a client terminal according to any of the client terminal embodiments is also provided herein.

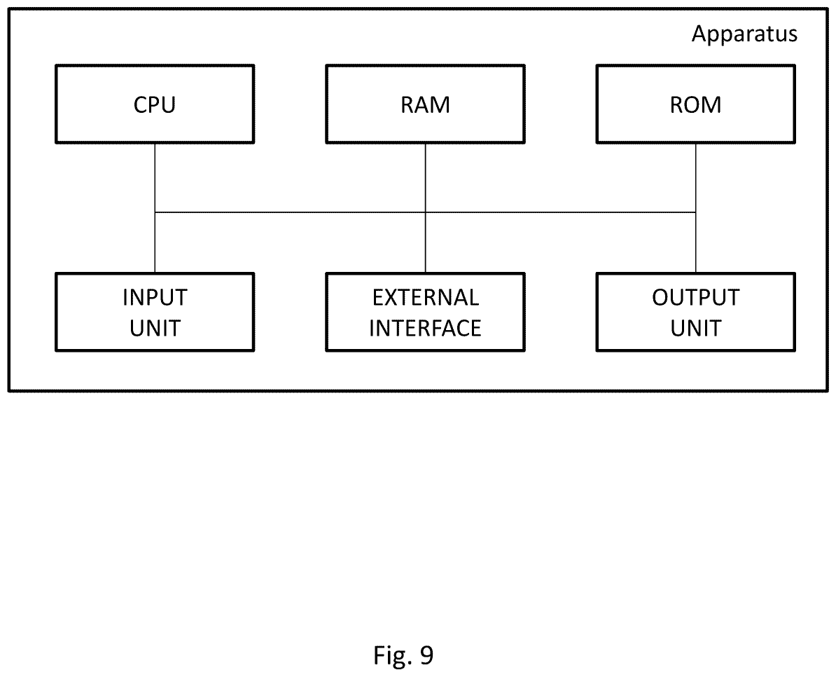

FIG. 9 illustrates the hardware that represents any of the server, the cloud service and/or client device that can be used in implementing the above described disclosure. The apparatus includes a CPU, a RAM, a ROM, an input unit, an external interface, and an output unit. The CPU controls the apparatus by using a computer program (one or more series of stored instructions executable by the CPU) and data stored in the RAM or ROM. Here, the apparatus may include one or more dedicated hardware or a graphics processing unit (GPU), which is different from the CPU, and the GPU or the dedicated hardware may perform a part of the processes by the CPU. As an example of the dedicated hardware, there are an application specific integrated circuit (ASIC), a field-programmable gate array (FPGA), and a digital signal processor (DSP), and the like. The RAM 306 temporarily stores the computer program or data read from the ROM, data supplied from outside via the external interface, and the like. The ROM stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of controlling a display of a client device connected to an online communication session, the method comprising
receiving, at a communication server from a client device, display control information assets that identify a display format and content streams being displayed on the client device operating in a first communication mode;
distributing, by the communication server, the provided control information to at least one other client device determined to be operating in the first communication mode; and
using, by the at least one other client device operating in the first communication mode, the distributed control information to obtain content streams and cause a user interface on the at least one other client device to have a same format and same content as the client device.

2. The method according to claim 1, further comprising
continually checking, by the communication server, at predetermined time intervals for updated control information; and
using, by the at least one other client device operating in the first communication mode, the updated control information to cause the user interface to be modified in accordance with the updated control information.

3. The method according to claim 1, further comprising;
receiving, by the communication server, an operational mode signal that indicates that the client device is caused to operate in the first communication mode; and
providing the operational mode signal to each of the at least one other client device;
causing the user interface on each of the other client devices to display a selectable image element on the user interface to notify the at least one other client device that the client device is operating in the first communication mode; and
enabling receipt of a selection by each respective one of the at least one other client devices indicating whether to operate in the first communication mode.

4. The method according to claim 3, wherein receipt of the selection indicating that the respective other client device is to operate in the first communication causes the respective other client device to use the distributed control information to cause the user interface to have the same format and same content as the client device.

5. The method according to claim 3, wherein receipt of the selection indicating that the respective other client device is not operating in the first communication mode causes the respective other client device to operate in a second communication mode whereby the respective other client device provides second control information to the communication server that allows a user of the respective other client device operating in the second mode to define its own display format and content.

6. The method according to claim 1, wherein display control information includes display format information indicating a number of individual display windows and respective sizes for each of the number of individual display windows.

7. The method according to claim 1, wherein the plurality of available content streams each have a respective content source identifier and is includes at least one or more of (a) first live video data captured by a first image capture device; (b) a second live vide data selected from a region within the first live video data; (c) a still image captured by the first image capture device or a second image capture device different from the first image capture device; and/or (d) data provided by an application executing on the client device.

8. The method according to claim 1, wherein the first operational mode is a leader mode identifying the client device as the leader and causes all other client devices connected to the communication server and operating in the first communication mode to be designated as a follower and have a same user interface and content view as the leader.

9. The method according to claim 1, further comprising:
receiving, by the communication server from one or more of the other client devices, a mode change signal indicating a change from the first communication mode to a second communication mode, whereby in the second communication mode the one of the one or more other client devices does not use the control information provided by the client device.

10. A communication server comprising:
one or more memories storing instructions; and
one or more processors that, upon execution of the stored instructions, are configured to execute operations comprising:
receiving, from a client device, display control information assets that identify a display format and content streams being displayed on the client device operating in a first communication mode;
distributing the provided control information to at least one other client device determined to be operating in the first communication mode; and
causing the at least one other client device operating in the first communication mode, the distributed control information to obtain content streams and cause a user interface on the at least one other client device to have a same format and same content as the client device.

11. The communication server method according to claim 10, wherein execution of the stored instruction further configures the one or more processors to execute the following operations:
continually checking, by the communication server, at predetermined time intervals for updated control information; and
using, by the at least one other client device operating in the first communication mode, the updated control information to cause the user interface to be modified in accordance with the updated control information.

12. The communication server to claim 10, wherein execution of the stored instruction further configures the one or more processors to execute the following operations:
receiving, by the communication server, an operational mode signal that indicates that the client device is caused to operate in the first communication mode; and
providing the operational mode signal to each of the at least one other client device;
causing the user interface on each of the other client devices to display a selectable image element on the user interface to notify the at least one other client device that the client device is operating in the first communication mode; and
enabling receipt of a selection by each respective one of the at least one other client devices indicating whether to operate in the first communication mode.

13. The communication server according to claim 12, wherein receipt of the selection indicating that the respective other client device is to operate in the first communication causes the respective other client device to use the distributed control information to cause the user interface to have the same format and same content as the client device.

14. The communication server according to claim 10, wherein display control information includes display format information indicating a number of individual display windows and respective sizes for each of the number of individual display windows.

15. The communication server according to claim 10, wherein the first operational mode is a leader mode identifying the client device as the leader and causes all other client devices connected to the communication server and operating in the first communication mode to be designated as a follower and have a same user interface and content view as the leader.

16. A client terminal comprising:
a display;
one or more memories storing instructions; and
one or more processors that, upon execution of the stored instructions, is configured to:
connect a communication server that facilitates communication between the client terminal and other client terminals remotely located from the client terminal;
cause a user interface to be displayed on a display device, the user interface including user selectable image elements enabling selection of a number of windows to be displayed concurrently within the user interface, and
select of one or more content streams from a plurality of candidate content streams for inclusion in respective ones of the selected number of windows being displayed concurrently;
generate control information that defines a format of the user interfaces displayed on the client terminal and identifiers indicating respective sources of the content stream associated with the selected windows; and
provide the generated control information to the server which distributes the control information to the other client terminals to cause the user interfaces on the other client terminals to use the control information to mirror the display and content streams of the client terminal.

17. The client terminal according to claim 16, wherein execution of the stored instructions further configures the one or more processors to:
continually monitor the user interface for any changes in number of windows selected for concurrent display and changes in content being associated with any selected windows; and
updating the control information to reflect the changes when it is determined that a change has occurred; and
providing updated control information at a predetermined interval to the communication server to update displays on the other client terminals.

18. The client terminal according to claim 16, wherein, in response to determining no change has occurred provide the generated control information at the predetermined interval to the communication server.

19. The client terminal according to claim 16, wherein execution of the stored instructions further configures the one or more processors to
receive a notification from the communication server issued by one of the other client terminals indicating that the one of the other client terminals intends to operate in the communication mode to mirror a user interface of the other client terminal on the client terminal; and
generate a message corresponding to the received notification for display in the user interface; and
receive a selection from within the generated message indicating whether the client terminal will enter the communication mode.
